(19) United States
(12) Patent Application Publication
(10) Pub. No.: US 2012/0152269 A1
(43) Pub. Date: Jun. 21, 2012

(54) DENTAL FLOSS DEVICE

(76) Inventor: Yair DAVID, Ramat Hasharon (IL)

(21) Appl. No.: 13/405,364

(22) Filed: Feb. 27, 2012

Related U.S. Application Data
(63) Continuation-in-part of application No. 12/901,536, filed on Oct. 10, 2010, now Pat. No. 8,127,778.

(51) Int. Cl. A61C 15/04; B65B 53/00; A61C 15/00

(52) U.S. Cl. 132/200; 132/321; 53/441

(57) ABSTRACT

A method and a dental floss device for floss the teeth of a user, and a production process of the dental floss device, in accordance with an embodiment of the present invention. The dental floss device includes a single use dental floss packaged inside a dental tubule. The dental tubule does not practically limit the bending capability of the dental floss.

### REFERENCE TO CROSS-RELATED APPLICATION

This application is a Continuation-in-Part of U.S. patent application Ser. No. 12/901,536 filed on Oct. 10, 2010.

This application claims priority benefits from U.S. patent application Ser. No. 12/901,536 filed on Oct. 10, 2010, herein incorporated by reference in its entirety.

### FIELD OF THE INVENTION

The present invention relates to oral hygiene, more particularly, to single use dental floss, and more particularly, to a dental floss device including dental floss packaged within a tubule.

### BACKGROUND OF THE INVENTION

To maintain dental hygiene, it is important to clean the teeth every so often, and to remove food remnants from between the teeth. At present, various means are used for this purpose, dental floss being one of the most efficient means currently available. One particularly popular means is lengths of waxed dental floss, contained within a dispenser, wound onto a spool, with one end protruding slightly. In preparation for use, the user pulls the end of the dental floss, exposing the desired length of floss from the dispenser, and then cuts it and uses it.

The length of the dental floss contained within the dispenser can be, for example, 50 meters. A typical length of the length cut for the purpose of use can be approximately 30 centimeters.

There are many situations in which a user knows that there will be a need for a single-use package of dental floss, such as for example, when going out to a restaurant and continuing straight on from there to another event. In this case, carrying a dispenser with an unnecessary length of floss is inconvenient.

In order to meet the need for a small and convenient means of dental flossing, several solutions have been propose, such as a fork-like device with two prongs and a short length of dental floss stretched between them. However, those who prefer a more thorough cleaning with the dental floss wound on their own fingers, one from each hand, do not find such solutions satisfactory.

Packages of short pieces of dental floss for single use have also been proposed.

An oral hygiene device, which is a disposable single use package, is described in U.S. Pat. No. 4,852,728 of Court.

FIG. 1 of the prior art illustrates the disposable single use package 60 of Court.

The single use package 60 includes a dental floss 10 at a length suitable for single use, a first triangularly shaped leaf 61 and a second triangularly shaped leaf 62. The first triangularly shaped leaf 61 and the second triangularly shaped leaf 62 are connected to each other by means of a common ridge. When in storage, they are folded onto each other, and prior to use, they are opened, to enable removal of the dental floss 10.

A single use dental floss dispenser is described in U.S. Pat. No. 5,582,194 of Dolan.

FIG. 2 of the prior art illustrates the single use dental floss dispenser 70 of Dolan.

The single use dental floss dispenser 70 of Dolan includes a dental floss 10 at a length suitable for single use, disposed within a cover portion 71, which is closed for storage by means of a lid portion 72. The lid portion 72 is opened prior to use, to enable removal of the dental floss 10.

In spite of all of the known and existent solutions, there is still a need for a short length of dental floss, conveniently packaged for single use. It is possible to simply pre-cut a short length of dental floss and store it in one's pocket, until it is removed from the pocket for use. This would be the most convenient solution in terms of storage, volume, and weight; however, in this manner the dental floss cannot be kept sufficiently clean, and can cause infections in the user's mouth.

None of the prior art devices comprises all of the above characteristics and functions.

There is therefore a need for a device including a short length of dental floss, for single use, whose size, volume, weight, and pliability are similar to those of bare dental floss, while maintaining sanitary conditions during carrying in the user's pocket. Such a device would be suitable for use at restaurants and other such businesses and venues, similarly to toothpicks provided in a suitable dispenser on the table or countertop.

### SUMMARY OF THE INVENTION

The background art does not teach or suggest a short length of single use dental floss, which is contained in a protective package prior to use, the package adding minimal weight and volume, thus enabling convenient carrying, with the contained dental floss, in one's pocket.

The present invention overcomes these deficiencies of the background art by providing a short length of dental floss contained within a tubule.

According to the teaching of the present invention there is provided a dental floss device, the dental floss device including: (a) a dental tubule having a dental tubule first end, a dental tubule second end, a dental tubule interior diameter, a dental tubule outer diameter, a dental tubule length, and a dental tubule weight, wherein the dental tubule is made of material enabling bending the dental tubule at a bending radius smaller than five millimeters; and (b) a dental floss having a dental floss first end, a dental floss second end, a dental floss length approximately equal the length of the dental tubule, a dental floss outer diameter, and a dental floss weight, wherein most of the dental floss is contained within the dental tubule, the dental floss has an exposed segment which extends longitudinally beyond the second end of the dental tubule.

According to another feature of an embodiment of the present invention, substantially the dental tubule has no elasticity.

According to another feature of an embodiment of the present invention the dental tubule has an open end and a closed end.

According to another feature of an embodiment of the present invention the dental tubule has empty segment, wherein the empty segment includes no dental floss.

According to another feature of an embodiment of the present invention the dental tubule interior diameter is substantially equal to the dental floss outer diameter.

According to another feature of an embodiment of the present invention there is an overlapping zone between the dental tubule and the dental floss, wherein along the entire of the overlapping zone, the dental tubule interior diameter is substantially equal to the dental floss outer diameter, wherein along the entire of the overlapping zone there is substantially a full contact between the dental tubule and the dental floss and wherein the dental tubule is substantially pressing on the dental floss along the entire of the overlapping zone.

According to another feature of an embodiment of the present invention there is an overlapping zone between the dental tubule and the dental floss, and wherein the dental tubule is substantially pressing on the dental floss at least along ten percent of the overlapping zone and at most along ninety percent of the overlapping zone.

According to another feature of an embodiment of the present invention a friction coefficient between the dental tubule and the dental floss, and a pressure of the dental tubule, acting on the dental floss, produce a resistance force to a pulling force, wherein in order to pull out the dental floss from the dental tubule there is a need to apply a pulling force which is large than the resistance force.

According to another feature of an embodiment of the present invention the resistance force has at least a predetermined resistance force value.

According to another feature of an embodiment of the present invention the resistance force has at least a value twice of the dental floss weight value.

According to another feature of an embodiment of the present invention the dental tubule has substantially the same bending characteristics as the bending characteristics of the dental floss.

According to another feature of an embodiment of the present invention the dental tubule is made of material selected from a group consisting of polyisoprene, latex and polyurethane.

According to the teaching of the present invention there is provided a method for using a dental floss to floss tooth of a user, the method including the stages of: (a) gripping with one hand an exposed segment of a dental floss, and gripping with the other hand an empty segment of a dental tubule, wherein the empty segment includes no dental floss; (b) pulling with one hand the exposed segment of the dental floss, and pulling with the other hand the empty segment of the dental tubule in an opposite directions; (c) extracting the dental floss fully from the dental tubule; (d) winding edges of the dental floss on the user's own fingers, at least one finger from each hand; and (e) cleaning between the teeth, with the dental floss that was extracted, wherein the dental floss is wound on the user's own fingers, one from each hand.

According to another feature of the method for using a dental floss to floss tooth of a user of the present invention, the dental tubule is made of material enabling bending the dental tubule at a bending radius smaller than five millimeters.

According to another feature of the method for using a dental floss to floss tooth of a user of the present invention, the dental tubule has substantially the same bending characteristics as bending characteristics of the dental floss.

According to the teaching of the present invention there is provided a process for producing dental floss device including the stages of: (a) threading a dental floss into a dental tubule, wherein the dental tubule is made of material enabling bending the dental tubule at a bending radius smaller than five millimeters; (b) shifting the dental floss inside the dental tubule, leaving an empty segment, wherein the empty segment includes no dental floss; and (c) shrinking the dental tubule and causing the dental tubule to press on the dental floss.

According to another feature of the process for producing a dental floss device of the present invention, the process further includes the stages of: (d) bending the dental tubule and the dental floss; and (e) attaching the dental tubule to a card.

According to another feature of the process for producing a dental floss device of the present invention, the process further includes the stages of: (d) bending the dental tubule and the dental floss into a helix spiral shape; and (e) attaching the dental tubule to a card.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 of the prior art illustrates a disposable single use package.

FIG. 2 of the prior art illustrates a single use dental floss dispenser.

FIG. 3a is a side view schematic illustration of a dental floss device, in accordance with an embodiment of the present invention, upon which a section plane a-a is marked.

FIG. 3b is a side view schematic illustration of a dental floss device, including a cap, in accordance with an embodiment of the present invention.

FIG. 4 is a side view schematic illustration of a dental tubule of the dental floss device, in accordance with an embodiment of the present invention.

FIG. 5 is a side view schematic illustration of a dental floss of the dental floss device, in accordance with an embodiment of the present invention.

FIG. 6 is a cross sectional view a-a of a dental floss device, in accordance with an embodiment of the present invention.

FIG. 7 is a top view schematic illustration of a dental floss device, in accordance with an embodiment of the present invention.

FIG. 8 is a side view schematic illustration of two hands performing an operating stage of the dental floss device, in accordance with an embodiment of the present invention.

FIG. 9 is a side view schematic illustration of a threading device, dental tubule, and a dental floss, in accordance with an embodiment of the present invention.

FIG. 10 is three side view schematic illustrations of dental tubules, and dental flosses, at three production process states in accordance with an embodiment of the present invention.

FIG. 11 is a flow chart that schematically illustrates a method for using dental floss to floss the teeth of a user, in accordance with an embodiment of the present invention.

FIG. 12a is a top view schematic illustration of a dental floss device, in accordance with an embodiment of the present invention.

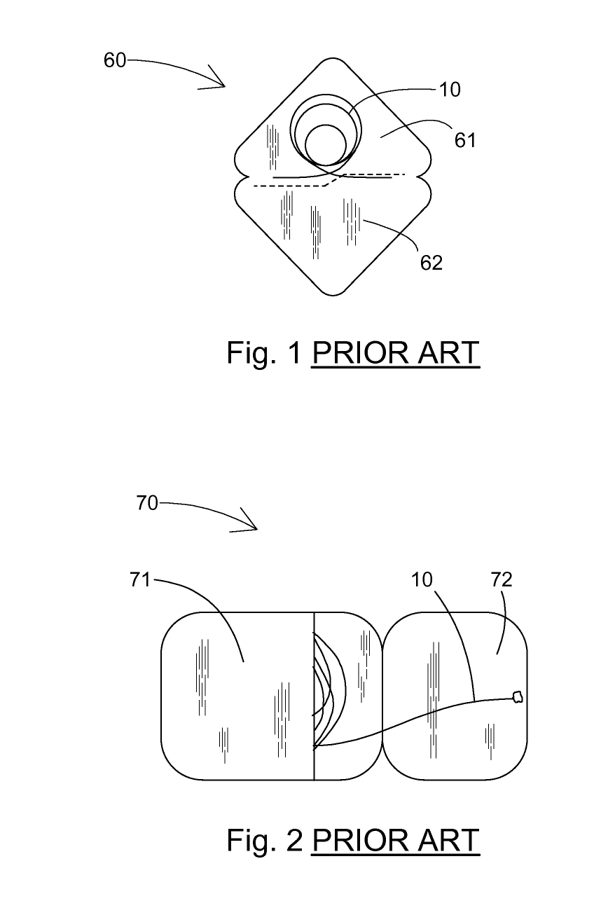

In order to leave no room for doubt, the elements shown in the illustrations of the present patent application in a manner that enables understanding them clearly, and the scales, size relations, and shapes are not in any way limiting their embodiment.

### DETAILED DESCRIPTION OF EMBODIMENTS OF THE INVENTION

To remove any doubt, note that the manner in which the elements of the present invention are described in the illustrations can be highly detailed, however is not in any way limiting the present illustration, however is for the purpose of clarification and furthering understanding. The present invention can be implemented in embodiments that differ from the specification given with regard to the illustration.

The present invention is of a dental floss device. The principles and operation of a dental floss device according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

As used herein the specification and in the claims section that follows, the term ‘single use’ refer to a use of the dental floss device for cleaning in one session between the teeth of a user.

This definition is to distinguish this use from that of a long length of dental floss, from which dental floss is occasionally cut at the desired length for cleaning between the teeth, with the long length of dental floss being able to be cut many times, until there is not enough dental floss left for use.

As used herein the specification and in the claims section that follows, the term ‘dental tubule’ refer to a tubule having suitable qualities for use as a component of a dental floss device, according to the present invention.

The following list is a legend of the numbering of the application illustrations:
10 dental floss
10a dental floss first end
10b dental floss second end
10l dental floss length
10od dental floss outer diameter
10W dental floss weight
11 exposed segment
20 dental tubule
20a dental tubule first end
20b dental tubule second end
20id dental tubule interior diameter
20l dental tubule length
20od dental tubule outer diameter
20W dental tubule weight
21 empty segment
25 cap
27 overlapping zone
29 bending radius
31 local gap
40l left hand
40r right hand
threading device
51 hook
60 disposable single use package, (prior art, according to Court)
61 first triangularly shaped leaf, (prior art, according to Court)
   62 second triangularly shaped leaf, (prior art, according to Court)
   70 dental floss dispenser, (prior art, according to Dolan)
   71 cover portion, (prior art, according to Dolan)
   72 lid portion, (prior art, according to Dolan)
   80 card
   82 adhesive layer
   100 dental floss device
   F force
   P pressure

Hereinafter, embodiments of the present invention are explained in detail by referring to the drawings.

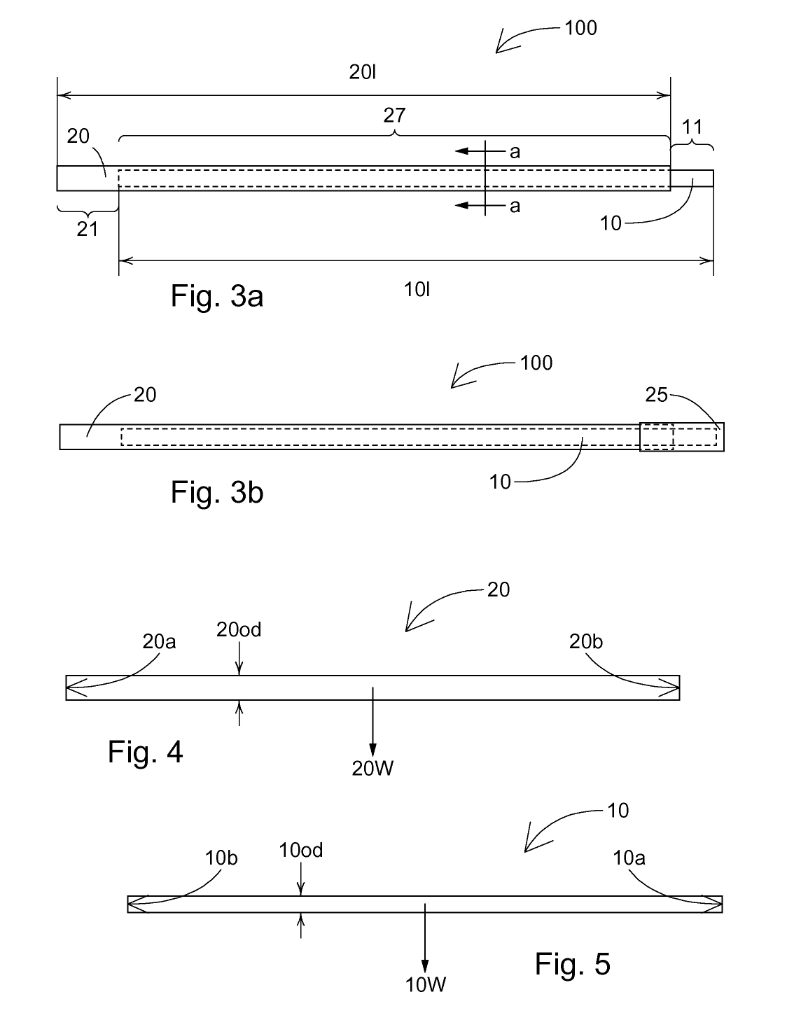

FIG. 3a is a side view schematic illustration of a dental floss device 100, in accordance with an embodiment of the present invention, upon which a section plane a-a is marked.

The present illustration shows a state of storage and carrying of the dental floss device 100, however for the purpose of clarity, it is shown straight, without any folds.

A dental floss 10 having a dental floss length 10l is mostly disposed within a dental tubule 20. A minimal value of dental floss length 10l to enable an adult's use of dental floss 10 should be no shorter than 10 centimetres.

The value of dental floss length 10l above which there is a superfluous waste of dental floss 10 is no longer than 40 centimetres.

The dental tubule 20 has a dental tubule length 20l, is open at one end, and closed at the other end, to prevent infiltration of contaminants.

The dental floss 10 has an exposed segment 11, which serves the purpose of enabling the fingers of one hand of the user to grasp it, when pulling from the dental tubule 20, and the dental tubule 20 has an empty segment 21, which serves the purpose of enabling the fingers of the other hand of the user to grasp it when pulling. The segment of the dental tubule 20 containing the dental floss 10 is referred to as an overlapping zone 27. The overlapping zone 27 is at its largest during storage, and becomes smaller when pulling dental floss 10, and does not exist at all when the pulling is completed.

For the purpose of clarity of details, the present illustration, as well as some of the following illustrations, shows the dental floss 10 and the dental tubule 20 with exaggeratedly large diameters in proportion to their lengths, relative to their actual proportions.

The dental tubule 20 is designated to maintain the hygiene of the dental floss 10 contained within. The necessary features of the dental tubule 20 are imperviousness to contaminants and, as far as possible, not to create any bending restrictions, which do not apply to the dental floss 10 itself, while being strong enough to be resistant to tearing. Its structural material and dimensions should be selected accordingly. Possible materials also include plastic materials. The structural materials can be materials without any stretching qualities, or with stretching qualities such as polyisoprene, which is a natural polymer, strong and elastic, inert, and does not cause allergic reactions.

Additional suitable material also include latex, and polyurethane. However, these materials are in no way limiting the present invention.

FIG. 3b is a side view schematic illustration of a dental floss device 100, including a cap 25, in accordance with an embodiment of the present invention.

The addition of cap 25 improves the sterility of the dental floss 10.

FIG. 4 is a side view schematic illustration of a dental tubule 20 of the dental floss device 100, in accordance with an embodiment of the present invention.

Dental tubule 20 has a dental tubule first end 20a, a dental tubule second end 20b, a dental tubule outer diameter 20od, and a dental tubule weight 20W.

FIG. 5 is a side view schematic illustration of a dental floss 10 of the dental floss device 100, in accordance with an embodiment of the present invention.

The dental floss 10 has a dental tubule first end 10a, a dental tubule second end 10b, a dental floss outer diameter 10od, and a dental floss weight 10W.

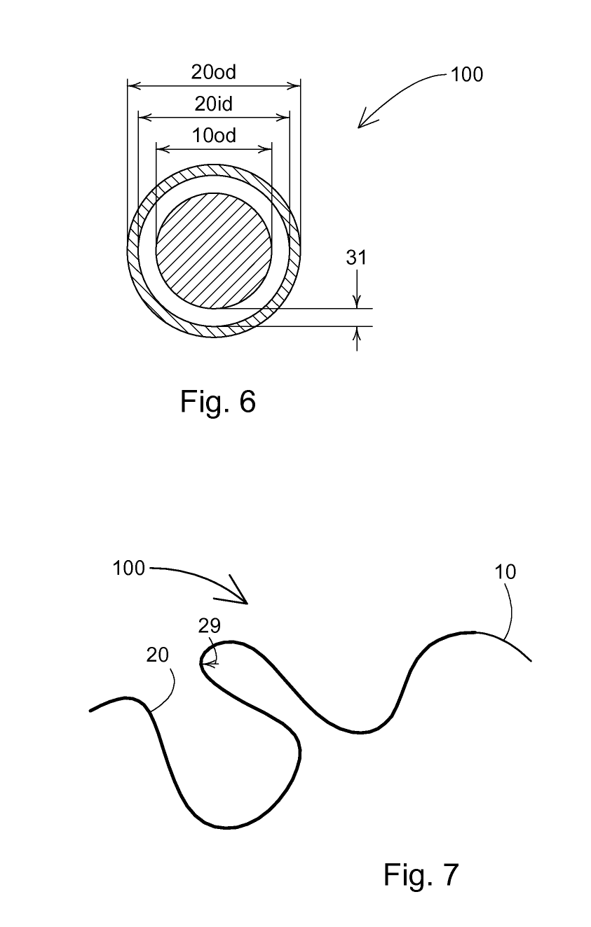

FIG. 6 is a cross sectional view a-a of a dental floss device 100, in accordance with an embodiment of the present invention.

The dental floss 10 has also a dental tubule interior diameter 20id.

A local gap 31, the value of which can vary in different locations along the cross section, and along the overlapping zone 27, (not shown in the present illustration, shown in FIG. 3a) can exist between the dental floss 10 and the dental tubule 20.

FIG. 7 is a top view schematic illustration of a dental floss device 100, in accordance with an embodiment of the present invention.

The illustration demonstrates the torsion of the dental floss device 100.

A bending radius 29, no larger than 5 millimeters, is sufficient for all practical purposes of carrying the dental floss device 100.

A quantity of dental floss devices 100 can be packaged, for the purpose of sale, in bags or boxes, or can be sold in bulk.

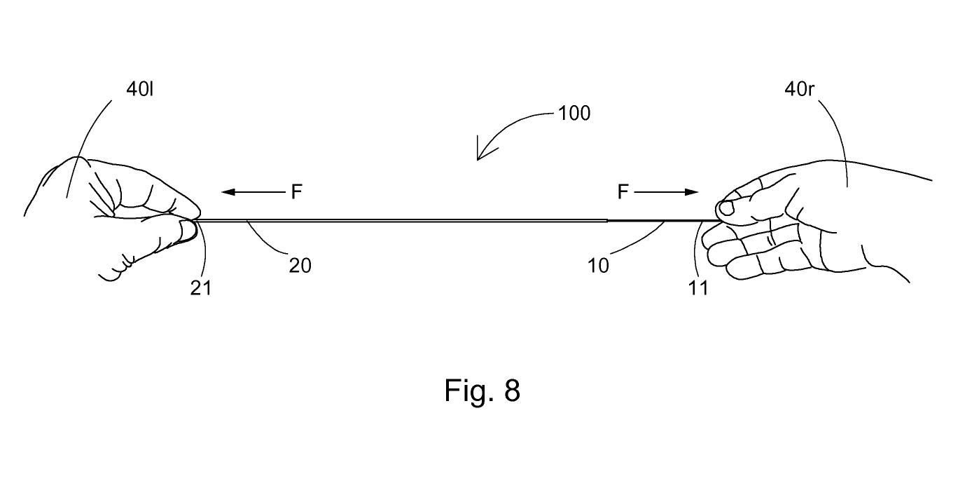

FIG. 8 is a side view schematic illustration of two hands performing an operating stage of the dental floss device 100, in accordance with an embodiment of the present invention.

In the case shown in the present illustration, the left hand 40l grips the empty segment 21, the right hand 40r grips the exposed segment 11, and each one pulls with force F for the purpose of removal. The force required for removal grows smaller as the removal progresses. The necessary force is determined also by the friction coefficient, the compacting force, if existent, applied by the dental tubule 20 on the dental floss 10 and the length of the overlapping zone 27 (indicated in FIG. 3a).

The necessary force F must not be too small, in order to prevent accidental removal, but must also not be so large as to pose difficulty during removal and to risk tearing the dental tubule 20 during removal. Therefore, the design and production of the dental floss device 100 are performed so that the necessary force F will be in the range between two predetermined values.

A reasonable minimal value of force F, under which removal will not occur, which is the larger of twice the dental tubule weight 20W and twice the dental floss weight 10W.

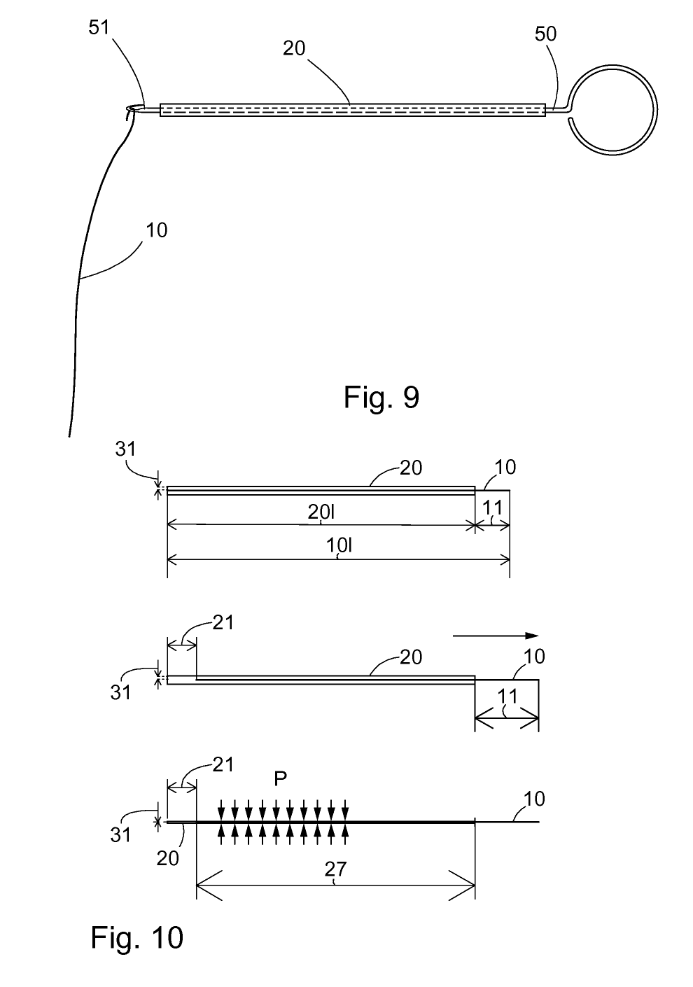

FIG. 9 is a side view schematic illustration of a threading device 50, dental tubule 20, and a dental floss 10, in accordance with an embodiment of the present invention.

The present illustration shows a stage in one possible production process of the dental floss device 100, according to the present invention.

A hook 51 of a threading device 50, threaded through dental tubule 20 is connected to dental floss 10, which will be later pulled and threaded through the dental tubule 20.

There is a range of options for the measure of compacting force activated by the dental tubule 20 on the dental floss 10, starting from no compacting at all, through a state of compacting resulting from the use of a narrow dental tubule 20, a state of compacting as a result of use of a narrow dental tubule 20 made of elastic material, to performing a shrink wrap of the dental tubule 20 after completion of threading.

Another good option is to create a state of compacting along only a short segment in close proximity to dental floss second end 10b (indicated on FIG. 5). This possibility is advantageous in that only at the beginning of the removal process is there a need for force, and most of the length of dental floss 10 does not come into contact almost at all with the internal wall of the dental tubule 20 so that if it is coated with or immersed in materials, they will not be diminished in the removal process.

FIG. 10 is three side views schematic illustration of dental tubules 20, and dental flosses 10, at three production process states in accordance with an embodiment of the present invention.

The dental tubules 20 are shown in the present illustration as translucent.

These stages are parts of a possible production process, however this process is not the only possible option, and is not limiting the present invention.

In the first stage of the three stages, shown in the upper part of the present illustration, a dental floss 10 is disposed within a dental tubule 20, for the entirety of the dental tubule length 20l and has an exposed segment 11 on one of its sides.

At this stage, there can be a local gap 31, as was described with regard to FIG. 6, for the entirety of the dental tubule length 20l, which is longer than zero, for the entire length or part of the length, and at any rate, there will be no force between the dental tubule 20 and dental floss 10 that will effectively disrupt their separation by pulling.

The second of the three stages is shown in the central part of the illustration, showing the dental floss 10 after having being pulled in the direction of the arrow shown next to it such that the value of the exposed segment 11 grows, and the empty segment 21 is generated. Namely, a shift of the dental floss 10 occurred within the dental tubule 20.

The last of the three stages is shown at the bottom part of the present illustration, showing a state in which shrinking of the dental tubule 20 was performed, which is mostly manifest in the decrease of the value of the dental tubule interior diameter 20id (not marked in the present drawing, shown in FIG. 6), generating pressure P of the dental tubule 20 on the dental floss 10 for the entire length of the overlapping zone 27, or part of its length.

A good way of shrinking dental tubule 20 is by making it of a material suitable for shrinking by means of heat at a temperature significantly above room temperature, to a shrunken state that is stable after heating.

A preliminary stage to the three stages described above can include cutting to segments of a desired length of a long dental tubule 20, containing a long dental floss 10, exposure of the edges, and performance of the noted stages.

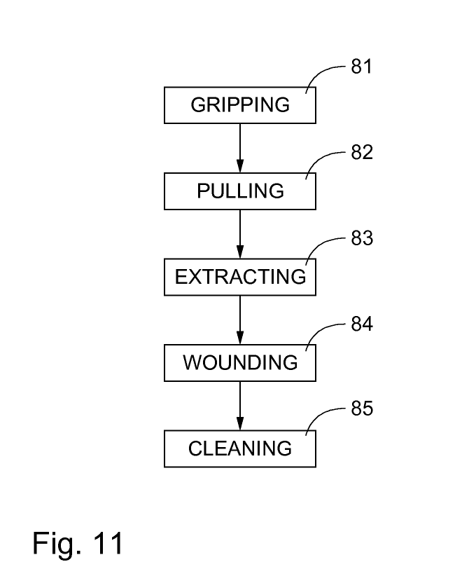

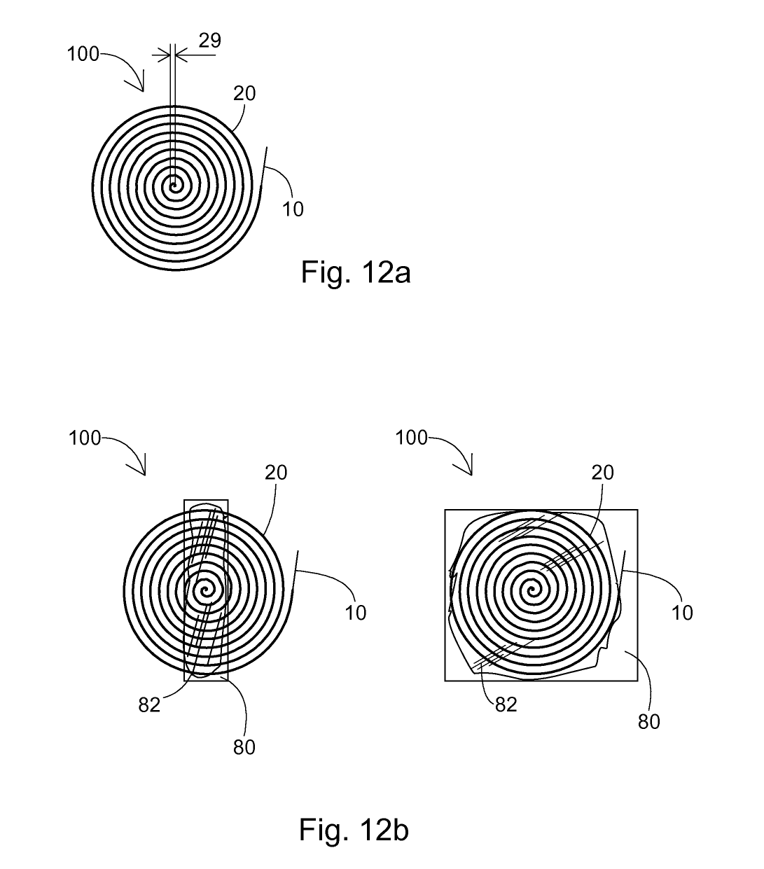

FIG. 11 is a flow chart that schematically illustrates a method for of using a dental floss to floss tooth of a user, in accordance with an embodiment of the present invention.

The method includes the stages of:

gripping with one hand the exposed segment of a dental floss, and gripping with the other hand an empty segment of a dental tubule, wherein the empty segment includes no dental floss, (stage 81);

pulling the exposed segment of a dental floss, and pulling with the other hand the empty segment of a dental tubule in an opposite directions, (stage 82);

extracting the dental floss fully from the dental tubule, (stage 83);

winding edges of the dental floss on said user's own fingers, one from each hand, (stage 84); and

cleaning between the teeth, with the dental floss that was extracted, (stage 85).

FIG. 12a is a top view schematic illustration of a dental floss device 100, in accordance with an embodiment of the present invention.

The dental floss device 100 includes a dental tubule 20, containing dental floss 10 partly protruding from within the dental tubule 20 and it is wound as a helix spiral. This shape is very convenient for the storage and carrying of the dental floss device 100.

At the most internal segment of the helix spiral, the dental floss device 100 has a bending radius 29 which can be very close to zero if the dental tubule 20 is made of a suitable material and has a suitable wall thickness to enable bending to a similar extent to that of the dental tubule 20.

A practical bending radius 29 of an order of magnitude of 5 millimeters is sufficient. This value, such as other values of technological elements, is a chosen value and not a specific discrete value. An example of a discrete value is the given speed limit for a road when it is clear that one mph more or less is not significant, however, for practical purposes, it is useful to establish the speed limit at a specific given number. Another example is the maneuvering limit given to combat pilots in G values. In this case as well, there is no one specific value, however pilots are strictly prohibited from exceeding the known discrete value, so as not to exceed the safety limit. The values for the dimensions and forces noted in the present patent application were chosen in a similar manner.

For the dental floss device 100 to remain in its folded state, the dental tubule 20 should not have any elasticity.

FIG. 12b is a top view schematic illustration of two dental floss devices 100, in accordance with an embodiment of the present invention.

Each dental floss device 100 includes a dental tubule 20 containing dental floss 10, partly protruding from the dental tubule 20. It is wound as a helix spiral and attached to a card 80. The attachment can be by means of an adhesive layer 82.

The adhesive layer 82 can be continuous upon the entire surface area of the card 80 upon which the dental tubule 20 is placed, or on part of it, or even not continuously.

Both parts of the present illustration show cards 80 with different dimensions and shapes and according to the present invention, many different configurations are possible.

This dental floss device 100 is very convenient for storage and portability, and prior to use, the dental tubule 20 and the dental floss 10, are removed from the card 80.

While the invention has been described with respect to a limited number of embodiments, it will be appreciated that many variations, modifications and other applications of the invention may be made.

What is claimed is:

1. A dental floss device comprising:
(a) a dental tubule having a dental tubule first end, a dental tubule second end, a dental tubule interior diameter, a dental tubule outer diameter, a dental tubule length, and a dental tubule weight, wherein said dental tubule is made of material enabling bending said dental tubule at a bending radius smaller than five millimeters; and
(b) a dental floss having a dental floss first end, a dental floss second end, a dental floss length approximately equal said length of said dental tubule, a dental floss outer diameter, and a dental floss weight, wherein most of said dental floss is contained within said dental tubule, said dental floss having an exposed segment which extends longitudinally beyond said second end of said dental tubule.

2. The dental floss device of claim 1, wherein said dental tubule substantially has no elasticity.

3. The dental floss device of claim 2, wherein said dental tubule has an open end and a closed end.

4. The dental floss device of claim 2, wherein said dental tubule has empty segment, wherein said empty segment includes no dental floss.

5. The dental floss device of claim 4, wherein said dental tubule interior diameter is substantially equal to said dental floss outer diameter.

6. The dental floss device of claim 4, wherein there is an overlapping zone between said dental tubule and said dental floss, wherein along the entire of said overlapping zone, said dental tubule interior diameter is substantially equal to said dental floss outer diameter, wherein along the entire of said overlapping zone there is substantially a full contact between said dental tubule and said dental floss and wherein said dental tubule is substantially pressing on said dental floss along the entire of said overlapping zone.

7. The dental floss device of claim 4, wherein there is an overlapping zone between said dental tubule and said dental floss, and wherein said dental tubule is substantially pressing on said dental floss at least along ten percent of said overlapping zone and at most along ninety percent of said overlapping zone.

8. The dental floss device of claim 4, wherein a friction coefficient between said dental tubule and said dental floss, and a pressure of said dental tubule, acting on said dental floss, produce a resistance force to a pulling force, wherein in order to pull out said dental floss from said dental tubule there is a need to apply a pulling force which is large than said resistance force.

9. The dental floss device of claim 8, wherein said resistance force has at least a predetermined resistance force value.

10. The dental floss device of claim 8, wherein said resistance force has at least a value twice of said dental floss weight value.

11. The dental floss device of claim 8, wherein said resistance force has at least a value of twice said dental tubule weight value.

12. The dental floss device of claim 4, wherein said dental tubule has substantially the same bending characteristics as bending characteristics of said dental floss.

13. The dental floss device of claim 4, wherein said dental tubule is made of material selected from a group consisting of polyisoprene, latex and polyurethane.

14. A method for using a dental floss to floss tooth of a user, the method comprising the stages of:
(a) gripping with one hand an exposed segment of a dental floss, and gripping with the other hand an empty segment of a dental tubule, wherein said empty segment includes no dental floss;
(b) pulling with one hand said exposed segment of said dental floss, and pulling with the other hand said empty segment of said dental tubule in an opposite directions;
(c) extracting said dental floss fully from said dental tubule;
(d) winding edges of said dental floss on said user's own fingers, at least one finger from each hand; and
(e) cleaning between the teeth, with said dental floss that was extracted, wherein said dental floss is wound on said user's own fingers, one from each hand.

15. The method for using a dental floss to floss tooth of a user of claim 14, wherein said dental tubule is made of material enabling bending said dental tubule at a bending radius smaller than five millimeters.

16. The method for using a dental floss to floss tooth of a user of claim 14, wherein said dental tubule has substantially the same bending characteristics as a bending characteristics of said dental floss.

17. A process for producing dental floss device comprising the stages of:
(a) threading a dental floss into a dental tubule, wherein said dental tubule is made of material enabling bending said dental tubule at a bending radius smaller than five millimeters;
(b) shifting said dental floss inside said dental tubule, leaving an empty segment, wherein said empty segment includes no dental floss; and
(c) shrinking said dental tubule and causing said dental tubule to press on said dental floss.

18. The process for producing dental floss device of claim 17 further comprising the stages of:
(d) bending said dental tubule and said dental floss; and
(e) attaching said dental tubule to a card.

19. The process for producing dental floss device of claim 17 further comprising the stages of:
(d) bending said dental tubule and said dental floss into a helix spiral shape; and
(e) attaching said dental tubule to a card.
